(19) United States
(12) Patent Application Publication
(10) Pub. No.: US 2024/0308630 A1
(43) Pub. Date: Sep. 19, 2024

(54) MODULAR SEMI-SUBMERSIBLE OFFSHORE PLATFORM

(71) Applicant: Aikido Technologies, Inc., San Francisco, CA (US)

(72) Inventors: Sam Kanner, San Francisco, CA (US); Bingbin Yu, San Francisco, CA (US); James Reeves, San Francisco, CA (US)

(21) Appl. No.: 18/608,256

(22) Filed: Mar. 18, 2024

Related U.S. Application Data
(60) Provisional application No. 63/490,930, filed on Mar. 17, 2023.
(60) Provisional application No. 63/618,546, filed on Jan. 8, 2024.

(51) Int. Cl. B63B 35/44; F03D 13/10

(52) U.S. Cl. CPC B63B 35/44; F03D 13/126; B63B 2035/446

(57) ABSTRACT

A semi-submersible offshore platform includes at least one truss having a central column with an upper end and a lower end, at least one float having an upper end and a lower end, the float spaced from the central column horizontally, at least one upper beam coupled to the upper end of the float and the upper end of the central column, at least one lower beam coupled to the lower end of the float and the lower end of the central column, at least one cross beam coupled to the lower end of the float and the upper end of the central column, wherein each of the at least one upper beam, the at least one lower beam and the at least one cross beam are coupled via a plurality of pins to the float and the central column.

### CROSS REFERENCE TO RELATED APPLICATIONS

This application claims the benefit of priority to a U.S. Provisional No. 63/490,930, filed on Mar. 17, 2023 and U.S. Provisional No. 63/618,546, filed on Jan. 8, 2024; the entire content of each of which is hereby incorporated by reference.

### BACKGROUND OF THE DISCLOSED SUBJECT MATTER

### Field of the Disclosed Subject Matter

The disclosed subject matter relates to a system for an offshore platform. Particularly, the present disclosed subject matter is directed to a modularly assembled semi-submersible offshore platform.

### Description of Related Art

Offshore floating platforms are designed to support offshore structures, such as wind turbines. One type of platform is known as a semi-submersible, which gets its stability from spatially separated buoyancy chambers. As the platform starts to pitch or roll, due to the effect of the wind turbine or other such external forcing (waves, currents), the change in the submerged volume of the buoyancy chambers results in a restoring force on the platform.

The vertical restoring force is related to the waterplane area of the structure. The pitch/roll restoring moment is related to the waterplane area moment of inertia, which is a function of the cross-sectional area of the buoyancy chambers and its distance away from the center of the platform. The larger the buoyancy chambers, or the further they are away from the center of the platform, the larger the restoring moment.

In general, large truss systems or pontoons are designed to transfer the buoyancy loads from outer buoyancy chambers to the center of the platform. The truss or system or pontoons also have to transfer loads in other directions from the outer columns (due to waves, currents, etc.) to the center column.

In general, the truss system or pontoons are connected to the buoyancy chambers via welded joints. To make the welded joints during the final assembly of the platform, requires significant time, space and manpower. Temporary structures (scaffolding) must be constructed in order for the welders to reach the joint areas.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a semi-submersible offshore wind turbine platform including at least one truss. The truss can include a central column, the central column having an upper end and a lower end, defining a length along a vertical axis therebetween, at least one float having an upper end and a lower end, defining a length along the vertical axis therebetween, the float spaced from the central column, at least one upper beam coupled to the upper end of the float and the upper end of the central column, at least one lower beam coupled to the lower end of the float and the lower end of the central column, wherein the lower beam is parallel to the upper beam, at least one cross beam coupled either to (a) the lower end of the float and the upper end of the central column or (b) the upper end of the float and the lower end of the central column, wherein each of the at least one upper beam, the at least one lower beam and the at least one cross beam are coupled via a plurality of pins to the float and the central column, and wherein at least one of the at least one upper beam, the at least one lower beam, and the at least one cross beam are configured to rotate about at least one pin.

In some embodiments, the float is spaced from the central column perpendicularly to the vertical axis.

In some embodiments, the at least one cross beam is configured to move about an axis of each of the pins in a plane parallel to the vertical axis.

In some embodiments, the at least one cross beam is alternatively coupled to the upper end of the float and the lower end of the central column.

In some embodiments, the at least one float is a buoyancy chamber.

In some embodiments, semi-submersible offshore platform further includes a tower affixed to the upper end of the central column along the vertical axis.

In some embodiments, the at least one upper beam is coupled to the upper end of the float with a first pin and to the upper end of the central column with a second pin. In some embodiments, the at least one lower beam is coupled to the lower end of the float with a third pin and to the lower end of the central column with a fourth pin. In some embodiments, the at least one cross beam is coupled to the lower end of the float with a fifth pin and to the upper end of the central column with a sixth pin.

In some embodiments, the at least one upper beam and at least one lower beam each define a length between float and central column, the axis being perpendicular to vertical axis of the central column.

In some embodiments, the at least one upper beam and at least one lower beam each define a length between float and central column defining an horizontal axis, the axis being about perpendicular to the vertical axis of the central column.

In some embodiments, the semi-submersible offshore platform further comprises a line connection at one or more of the lower end of the float and the lower end of the central column, the line connection facilitating a connection to an anchored tether.

In some embodiments, the at least one float includes three floats. The three floats are distributed circumferentially around the central column by about 120 degrees.

In some embodiments, the at least one float includes four floats. The four floats are distributed circumferentially around the central column by about 90 degrees. In some embodiments a greater number (i.e. more than four) floats can be employed; and all the floats can be equidistantly spaced (circumferentially) from each other.

In some embodiments, the semi-submersible offshore platform further includes an intermediary coupling that includes a first pin and an adjacent pin, an axis of a first pin being vertically offset from the axis of an adjacent pin. In some embodiments, the intermediary coupling can be used to couple (a) the at least one upper beam to the upper end of the float and the upper end of the central column, (b) the at least one lower beam to the lower end of the float and the lower end of the central column, and (c) at least one cross beam to one or more of the lower end of the float and the upper end of the central column are coupled using the intermediary coupling.

In some embodiments, an assembly rig for transporting a semi-submersible off-shore wind turbine platform includes a first cradle having a lower end and an upper end. The lower end and upper end define a first vertical length therebetween. The upper end of the first cradle forms a first mating interface for a first end of a first column. The assembly rig further includes a second cradle having a lower end and an upper end. The lower end and upper end define a second vertical length. The upper end of the second cradle has a second mating interface for a second end of the first column. The assembly rig includes a third cradle having a lower end and an upper end. The lower end and upper end define a third vertical length. The third cradle has a third mating interface for a first end of a second column. The assembly rig includes a fourth cradle having a lower end and an upper end. The lower end and upper end define a fourth vertical length. The upper end of the fourth cradle has a fourth mating interface for a first end of a beam attached to the second column. The assembly rig includes a fifth cradle having a lower end and an upper end. The lower end and the upper end define a fifth vertical length. The upper end of the fifth cradle has a fifth mating interface for a first end of a third column. The assembly rig includes a sixth cradle having a lower end and an upper end. The lower end and the upper end define a sixth vertical length. The sixth cradle having a mating interface for a second end of the third column. The first vertical length is less than the second vertical length. The third vertical length is less than the fourth vertical length. The fifth vertical length is less than the sixth vertical length. The first column, second column, third column, and the beam include pin joint interfaces thereon. When the first column, second column, third column, and the beam are coupled with the respective first, second, third, fourth, fifth, and sixth mating interfaces, the pin joint interfaces are aligned for pin insertion.

In some embodiments, the third cradle further includes a seventh mating interface for a second end of the beam.

In some embodiments, the assembly rig further includes a plurality of struts connecting, along a horizontal dimension, the first, second, third, fourth, fifth, and sixth cradles at their respective lower ends.

In some embodiments, the assembly rig further includes a plurality of skidding rails, and the assembly rig can be placed upon the skidding rails. The skidding rails are configured to mate with rail elements of the first, second, third, fourth, fifth, and sixth cradles. The mating allows the first, second, third, fourth, fifth, and sixth cradle to move along a horizontal dimension of the plurality of skidding rails.

In some embodiments, the plurality of skidding rails is aligned with a barge. The first, second, third, fourth, fifth, and sixth cradles can be loaded onto the barge.

In some embodiments, a method of assembling a semi-submersible wind turbine platform includes securing the floating column to a crane. The method further includes moving the floating column to a first cradle and second cradle of an assembly rig. The method further includes mounting a beam to a central column with a pin joint. The method further includes securing the central column to the crane. The method further includes moving the central column to a third and fourth cradle of the assembly rig. The method further includes aligning the floating column and the central column in the assembly rig such that a first pin joint interface of the beam mounted to the central column is aligned with a second pin joint interface of the floating column. The method further includes mounting the floating column to the beam by inserting a pin through the first pin joint interface and second pin joint interface.

In some embodiments, mounting a beam to the central column includes mounting a plurality of beams to the central column. In some embodiments, the plurality of beams can include one or more of an upper main beam, a lower main beam, and a cross beam. In some embodiments, the plurality of beams can include one or more of multiple upper main beams, multiple lower main beams, and multiple cross beams.

In some embodiments, a method of assembling a semi-submersible wind turbine platform includes mounting a beam to a floating column with a pin joint. The method further includes securing the floating column to a crane. The method further includes moving the floating column to a first cradle and second cradle of an assembly rig. The method further includes securing the central column to the crane. The method further includes moving the central column to a third and fourth cradle of the assembly rig. The method further includes aligning the floating column and the central column in the assembly rig such that a first pin joint interface of the beam mounted to the floating column is aligned with a second pin joint interface of the central column. The method further includes mounting the central column to the beam by inserting a pin through the first pin joint interface and second pin joint interface.

In some embodiments, mounting a beam to the floating column includes mounting a plurality of beams to the floating column. In some embodiments, the plurality of beams can include one or more of an upper main beam, a lower main beam, and a cross beam. In some embodiments, the plurality of beams can include one or more of multiple upper main beams, multiple lower main beams, and multiple cross beams.

In some embodiments, the floating column is a first floating column. The method further comprises securing a second floating column to the crane and moving the second floating column to a fifth cradle and sixth cradle of the assembly rig.

In some embodiments, the first cradle has an upper end and a lower end defining a first height. The second cradle has an upper end and a lower end defining a second height, and the first height is greater than the second height. The third cradle has an upper end and a lower end defining a third height. The fourth cradle has an upper end and a lower end defining a fourth height, and the third height is greater than the fourth height.

In some embodiments, the method further includes moving the assembly rig along skidding rails. The assembly rig has floating skids engaged with the skidding rails along an axis formed by a length of the skidding rails. The method further includes transferring the assembly rig from the skidding rails to a barge.

In some embodiments, the floating column, the central column, the at least one upper beam, the at least one lower beam, and the at least one cross beam compose the semi-submersible platform. The method further includes deploying the semi-submersible platform in water. The method further includes configuring the semi-submersible platform by moving the at least one upper beam and the at least one lower beam into position whereby an axis defined by a length of the coupling of the respective beams to the float column and central column is perpendicular to the vertical axis.

In some embodiments, deploying the semi-submersible platform can be performed by disconnecting the semi-submersible platform from the assembly rig and/or barge itself and then sinking or partially sinking the barge. After sinking or partially sinking the barge, the buoyancy in the semi-submersible platform (e.g., in the floats, central column, or other features) causes the platform to float. In some examples, the platform can float away with currents or winds. In some examples, the barge can navigate away from the platform, leaving the semi-submersible platform in place in the water. In some embodiments, the assembly rig remains on the barge as the semi-submersible platform is removed to be in the water. After the float has been removed from the barge, the barge can reverse the sinking or partial sinking process.

In some embodiments, the method includes mounting a second beam to the floating column. The method further includes aligning the floating column and the central column in the assembly rig such that a third pin joint interface of the second beam mounted to the floating column is aligned with a fourth pin joint interface of the central column.

In some embodiments, the method further includes connecting the semi-submersible platform to at a tether.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIG. 1 is an isometric view of a semi-submersible platform in an operational upright configuration in accordance with the disclosed subject matter.

FIG. 2A is a top view of the semi-submersible platform respectively in accordance with the disclosed subject matter.

FIG. 2B is a side view of the semi-submersible platform respectively in accordance with the disclosed subject matter.

FIG. 3 is an isometric view of a custom-designed assembly rig having cradles and space frames assembled on skidding rails in accordance with the disclosed subject matter.

FIG. 4 is an isometric view of a semi-submersible platform in an assembly and transport configuration on a custom-designed assembly rig with cradles and space frames in accordance with the disclosed subject matter.

FIG. 5 is a side view of a semi-submersible platform in an assembly and transport configuration and angled with respect to the ground wherein the angle is related to the heights of the cradles of a custom-designed assembly rig in accordance with the disclosed subject matter.

FIG. 6 is an isometric view of a semi-submersible platform in an assembly and transport configuration and an assembly rig assembled along skidding rails in accordance with the disclosed subject matter.

FIGS. 7A-B are views of a gantry crane lifting a column onto cradles of a custom-designed assembly rig in accordance with the disclosed subject matter.

FIGS. 8A-B are views of a gantry crane lifting a pre-assembled column with beams onto cradles of a custom-designed assembly rig in accordance with the disclosed subject matter.

FIG. 9 is a view of a gantry crane lifting a tower guided by column bumpers and column tower support in accordance with the disclosed subject matter.

FIGS. 10A-B are views of a gantry crane lifting a pre-assembled column with beams onto cradles of a custom-designed assembly rig in accordance with the disclosed subject matter.

FIG. 11 is a view of horizontal and vertical movements utilized by a crane to position a pre-assembled column with beams on cradles of a custom-designed assembly rig in accordance with the disclosed subject matter.

FIG. 12 is a top view of a semi-submersible platform in an assembly and transport configuration on a custom-designed assembly rig along skidding rails in accordance with the disclosed subject matter.

FIG. 13 is a view of the assembly site of the semi-submersible platform wherein a concrete slab with load spreading is embedded with sets of skidding rails and skid beams in accordance with the disclosed subject matter.

FIGS. 14A-B are views of floating skids used with a custom-designed assembly rig to skid an assembly rig and semi-submersible platform in accordance with the disclosed subject matter.

FIG. 15 is a view of a moored barge at the assembly site for a semi-submersible platform in accordance with the disclosed subject matter.

FIG. 16 is a view of a semi-submersible platform on a support frame on a barge in accordance with the disclosed subject matter.

FIG. 17 is a schematic of a semi-submersible platform with a mooring system connected to the outer columns in accordance with the disclosed subject matter.

FIG. 18 is a view of a semi-submersible platform in an operational upright configuration with mooring lines and anchors attached in accordance with the disclosed subject matter.

FIG. 19 is a zoom-in view of a lower coupling portion of the semi-submersible offshore platform in accordance with the disclosed subject matter.

FIG. 20 is a zoom-in view of a lower central coupling portion of the semi-submersible offshore platform in accordance with the disclosed subject matter.

FIG. 21 is an isometric view of a pin joint utilizing more than one pin connection in accordance with the disclosed subject matter.

FIG. 22 is an isometric view of a semi-submersible offshore platform wherein the main beams are connected via trusses in accordance with the disclosed subject matter.

FIG. 23 is a zoom-in view of an upper central coupling portion of the semi-submersible offshore platform in accordance with the disclosed subject matter.

### DETAILED DESCRIPTION OF AN EXEMPLARY EMBODIMENT

Reference will now be made in detail to exemplary embodiments of the disclosed subject matter, an example of which is illustrated in the accompanying drawings. The method and corresponding steps of the disclosed subject matter will be described in conjunction with the detailed description of the system.

The term “about” means a range of values inclusive of the specified value that a person of ordinary skill in the art would reasonably consider to be comparable to the specified value. In some embodiments, about means within a standard deviation using measurements generally accepted by a person of ordinary skill in the art. In embodiments, about means ranging up to ±10% of the specified value. In embodiments, about means ranging up to ±5% of the specified value. In embodiments, about means the specified value.

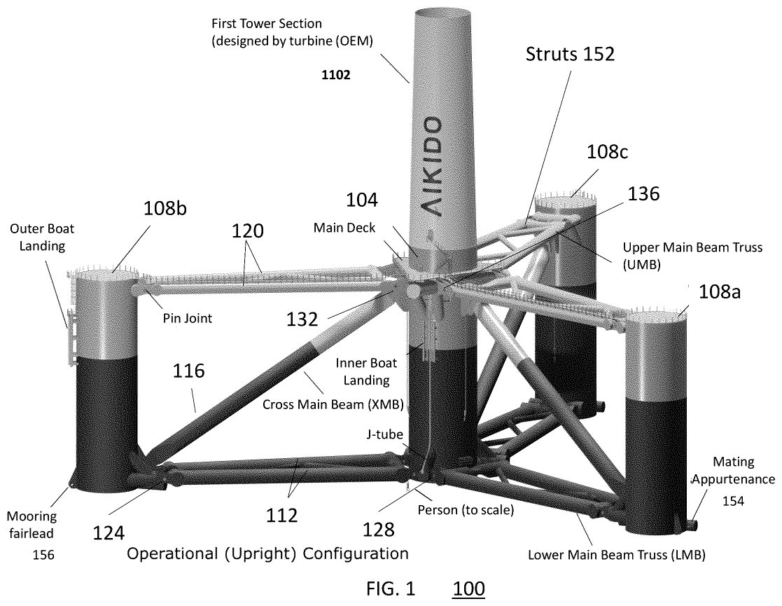

The methods and systems presented herein may be used for an offshore platform. The disclosed subject matter is particularly suited for semi-submersible offshore platform that can be assembled modularly. For purpose of explanation and illustration, and not limitation, an exemplary embodiment of the system in accordance with the disclosed subject matter is shown in FIG. 1 and is designated generally by reference character 100. Similar reference numerals (differentiated by the leading numeral) may be provided among the various views and Figures presented herein to denote functionally corresponding, but not necessarily identical structures.

As shown in FIG. 1, a semi-submersible platform 100 including a plurality of pinned tubulars is disclosed herein. An alternative joint that can be considered to connect various components together is a pinned joint. In a pin joint, not all forces and moments are transferred. In general, bending moments aligned with the pin axis are not transferred between members. In various embodiments, the struts or tubulars as described herein may take any number of cross-sectional shapes such as box structural steel, hollow beams, or the like. In various embodiments each beam as described herein may be optionally hollow. In various embodiments each beam as described herein may include internal structures or bracing. In various embodiments, each beam may include one or more ribs, bulkheads, spines, stringers, or the like at any point along its length, including the entire length of any beam. In various embodiments, each beam may be formed from steel, aluminum, alloys thereof, or another metal or metal alloy. In various embodiments each beam may be formed from composite laminates, such as resin-infused carbon fiber or fiberglass. In various embodiments, each beam may be constructed uniquely from the other beams present.

For example and without limitation, one beam such as the cross beam 116 may include solid construction or internal bracing structures to impart the compression load to the central column 104 while each of the upper beams 120 and lower beams 112 include a hollow construction or partially hollow construction. Additionally or alternatively, all beams can be hollow, or of solid cross-section, as desired. In various embodiments, each beam may include a range of wall thicknesses. For example and without limitation, the cross beam 116 may include thicker wall than the upper or lower beams 120, 112, respectively. In various embodiments, the wall thickness may vary along the length of a beam, for example the beam may have a thicker wall proximate any connection point or alternatively be thicker at the center of the length of the beam.

In various embodiments, central column 104 may be coupled to, or form the base of a wind turbine. In various embodiments, central column 104 may be coupled to or form the base of turbine blade configured to turn via interaction with ocean water. In various embodiments, platform 100 is configured to float at a desired depth in water, such as ocean water. In various embodiments, floats 108a-c may be configured to generate a predetermined buoyancy force, providing a water level 144 as desired for optimum power generation. In various embodiments, one or more floats 108a-c may be configured to rise or sink in the water, thereby changing water level 144. In various embodiments, any component herein may be treated for use within saltwater, such as having a protective coating or composition to resist rust or deterioration via exposure to the saltwater. In various embodiments, floats 108a-c may be configured to intake or expel certain ballast such as air or water in order to maneuver the platform 100 up or down in the water. In various embodiments, floats 108a-c may be configured to have weights selectively coupled thereto in order to adjust the depth of the platform 100 in water.

The platform 100 is designed such that all major loads on an offshore platform can be transferred efficiently. The platform includes a plurality of outer floats or buoyancy chambers 108 that are connected to each other or to a central column 104 by a truss system of pinned tubulars 112, 120. In various embodiments, there may be two or more radially spaced floats 108 about the central column 104, each connected by a truss. In various embodiments, there may be a plurality of floats at various radial distances from the central column 104, such as a first portion of floats 108 radially spaced around the central column 104 at a first distance, and a second portion of floats 108 radially spaced at a second distance from the central column 104. In various embodiments, there may be a subset of floats 108 spaced radially about the central column 104 in alternative distances therefrom. For purpose of illustration and not limitation, the exemplary embodiment shown in FIG. 1 includes three floats 108, each spaced equidistantly from the column 104 and equidistantly spaced from each other, e.g. 120 degrees apart, however alternative configurations are within the scope of the present disclosure. In some embodiments, the semi-submersible platform can include four float (not shown) that are equidistantly spaced from each other circumferentially about the central column, e.g., about 90 degrees apart, however alternative configurations are within the scope of the present disclosure.

In various embodiments, floats 108a-c (as shown in FIG. 1) may be formed as vertical columns, as shown in FIGS. 1-4. In various embodiments, floats 108a-c, may be formed as horizontal columns, with pin joints 124, 128, 132, 136 configured and placed thereon according to the forces acting on the float. In various embodiments, each float 108a-c may be formed as spheres, oblong spheroids, egg-shapes, rectangular prisms, or the like. In various embodiments, floats 108a-c may be formed with pin recesses integrated into the surface thereof (e.g. the pin(s) can be extend through a flange that protrudes laterally from the exterior circumferential surface of the float 108). In other words, the floats 108 and central column 104 can be cylindrical with a flange structure projecting radially outward, with that flange having an aperture or recess for receiving the pin therein; the pins do not penetrate into the floats 108 or central column 104.

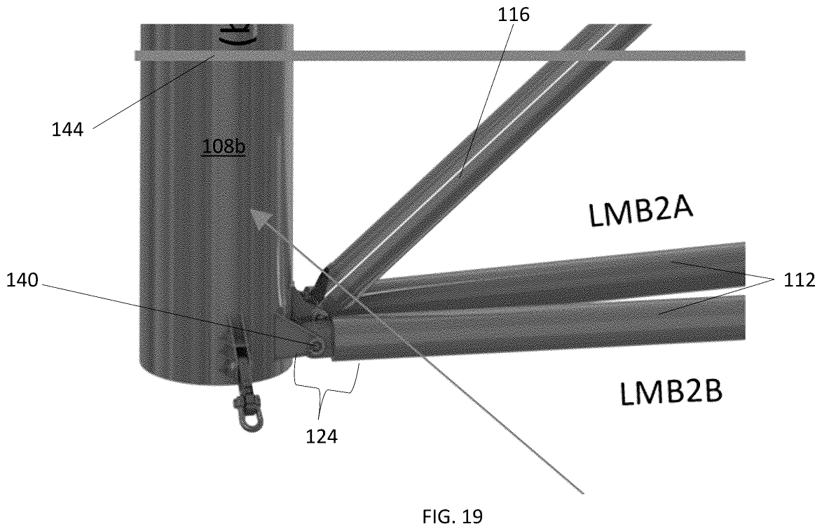

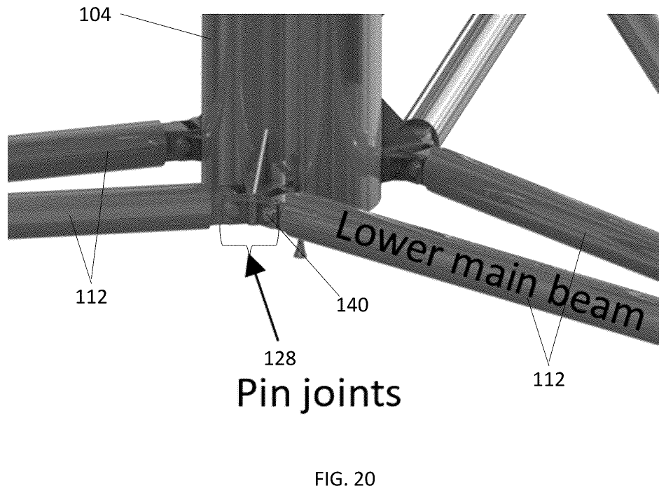

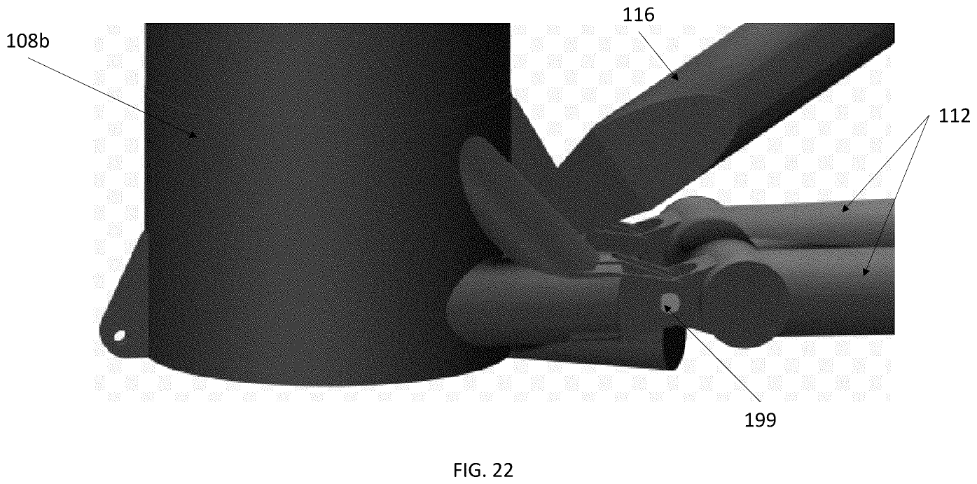

Some exemplary pin connections are depicted in FIGS. 19-21 (depicting a pin 140 within flanges extending from the cylindrical members. Some exemplary spherical bearing 199 connections are depicted in FIG. 22. Each of these connections (pin or spherical bearing) have a pivot axis which is external to and spaced from the cylindrical floats 108.

Additionally or alternatively, in various embodiments, floats 108a-c may be configured to be coupled to one or more pin recesses/receivers, for example by welding, fasteners, adhesives or the like. In some embodiments, the pin joint(s) are spherical joint(s) or spherical bearing(s)—these terms can be used interchangeably herein.

In various embodiments, each float 108 has five tubulars (beams): two upper main beams 120, one diagonal cross main beam 116 and two lower main beams 112. The main upper and lower beams 120, 112 are designed to withstand the loads that are transferred along each member. In the exemplary embodiment shown, the beams 120, 112 are connected to the float 108 at a location on the vertical side (e.g., spaced from the planar top/bottom surfaces of the float 108). Additionally, the beams 120, 112 are configured in angled or converging orientation with the outer (e.g., with respect to the central column) ends of the beams 120, 112 spaced closer to each other than the inner ends of the beams 120, 112. Also, the cross main beam 116 is configured to extend from an outer end of the lower beam 112, to an inner end of the upper beam 120. In the exemplary embodiment shown, cross main beam 116 is configured at about a 45° angle to the upper and lower beams 120, 112. In various embodiments, cross beam 116 may extend from an upper end of a float 108 to a lower end of central column 104 or a combination thereof. In various embodiments, cross beam 116 can be alternately connected radially about central column 104, such as spanning from an upper portion of central column 104 to a lower end of float 108, and vice versa in an alternating configuration for the number of floats 108 present.

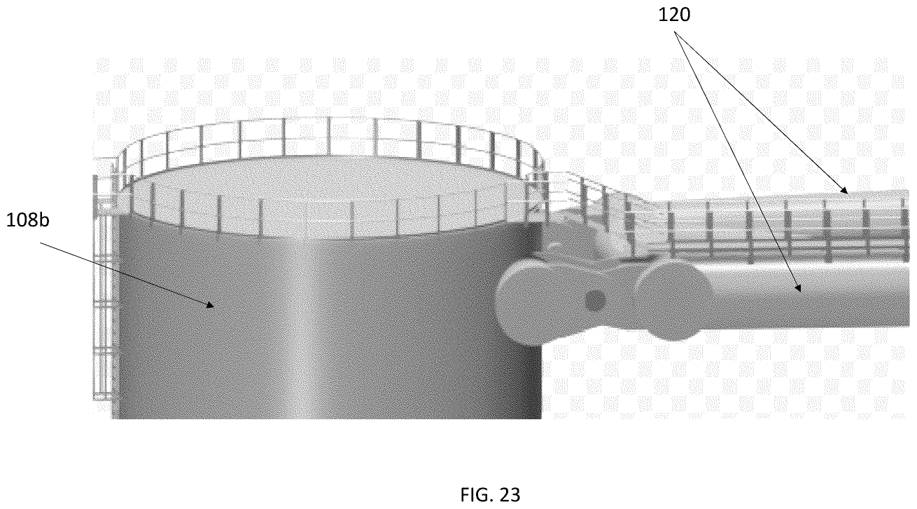

In other designs, the upper main beams 120 can be one beam, or can be two beams that are interconnected via a plate or similar. In other designs, the lower main beams 112 can be one beam, or can be two beams that are connected via a plate or similar. In various embodiments, the upper beams 120 may be connected by a strut 152 or a plurality thereof, spanning the distance therebetween, oriented perpendicular to the beam 120 and/or at an acute angle thereto, and welded or pinned to each of the upper beams 120. Struts 152 may be alternating and angled relative to the next proximate strut 152 to form a zig-zag pattern between the beams coupled thereto, such as upper beam 112 and lower beam 120. The cross main beam 116 can be oriented such that it is connected to a bottom portion of an outer float 108(a-c) at pin joint 124 and the upper portion of the central column 104 at pin joint 132, as shown in FIG. 1, or at the upper portion of the outer float 108(a-c) and the lower portion of the central column 104. In various embodiments, cross beam 116 may be similarly coupled to each of the float and central column or at adjusted or configured pin joints along the vertical axis of float 108a-c and/or central column 104. If the lower main beams 112 are connected via a plate, then the added mass and wave damping can be increased. The upper beams 120 can be coupled to the floats 108 via a pin joint that is formed between a pair of opposing flanges on each of the upper beam and float, as shown in FIG. 23. The pair of flanges extending from the upper beam 120 can be received within the pair of flanges extending from the float 108.

In some embodiments, advantages of the platform include that it can be manufactured from 13 major steel components using a distributed supply chain, assembled significantly faster than alternative platforms, using a custom-designed assembly rig, transported on conventional barges (e.g., 120 feet by 500 feet), and loaded-out with multiple options, such as submersible barge, skidway, drydock, ring crane, etc.

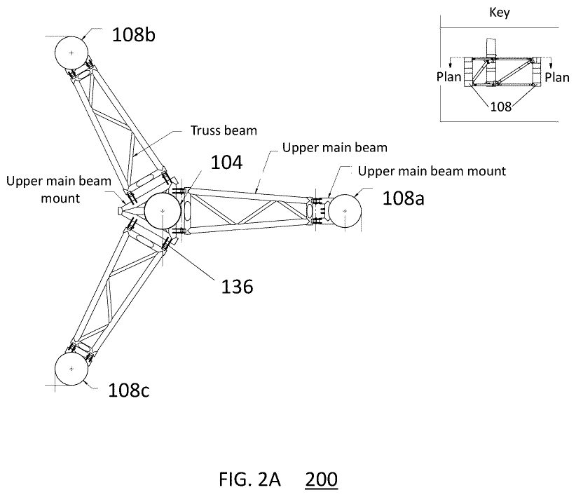

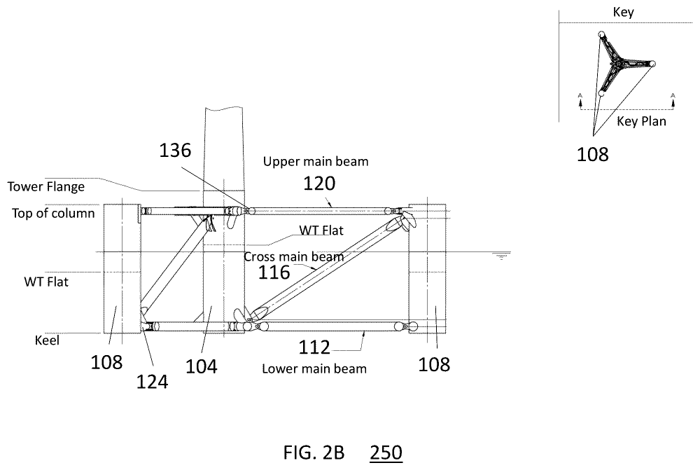

The platform 100 retains stability by transferring the buoyancy force from the outer columns 108a-c to the central column 104. The upper and lower main beams 120, 112 do not transfer the buoyancy force, due to the orientation of the pin joints 124, 136. The pin joints 124 and 136 are configured such that the pins lay in a plane orthogonal to the vertical axis of the floats (108a-c) and the central column 104, as illustrated by, for example, FIGS. 2A-B of the top view and side view of the platform 100. With reference to FIG. 1, the pin joints 124 allows each of the lower beams 112 to rotate in a plane parallel to the vertical axis of float 108a, therefore allowing the stresses and strains imparted on the platform to be transferred through the cross beam 116 and does not subject the joints to wear and tear, nor shear stress.

In various embodiments, each lower beam 112 may be coupled to the lower portion of float 108b horizontally spaced apart and at the same vertical location along the vertical axis of the float. In various embodiments, each of the lower beams 112 may be coupled to the float at varying vertical heights, for example stacked vertically and pinned thereto. In various embodiments, pin joint 124 may be adjustable in one or more planes of motion. For example and without limitation, pin joint 124 (as well as any other pin joint shown or described) may constrain rotation about the axis pin to a certain angle range. For example and without limitation, pin joint 124 may include one or more walls, bosses or other structure configured to inhibit or prohibit the rotation of any one of the beams coupled thereto. In various embodiments, rotations of beams about any pin as shown or described may be constrained by the length of the beams themselves within the truss. In various embodiments, the range of rotation of any of the beams about pin 140 may be adjusted based on weather conditions, number of floats or the like. For example, lower beams 112 may be constrained by pin joint 124 to only rotate 20 degrees in either direction about the pin 140. The cross main beam 116 transfers all of the buoyancy force. In general, the cross main beam 116 transfers the buoyancy force through compression, which is more than efficient than transferring the loads by local bending of welded joints between horizontal main beams and outer floats.

The other major loading on an offshore platform 100 are the waves and currents, which impact the platform mainly on the large floats 108a-c. Given the wave/current direction relative to the orientation of Float 1 (108a), the loads are transferred via the upper and lower beams 120, 112 in compression/tension. In general, wave forces are cyclic in nature, while current forces can be time-varying. Given the wave/current direction relative to the orientation of Float 2 108b (perpendicular to the truss ‘frame’), the loads can be transferred via compression of upper or lower MB2A and tension of upper or lower MB2B (each of the two upper main beams 120). In other words, when the force of the water is applied transverse to the truss system, for example at the side of float 2 108b, the wave-side upper and lower beams are subject to tension while the backside upper and lower beams are subject to compression.

The pin joints can also be modified so that only particular loads are transferred via each beam. For instance, the pin joints 124, 132 at the ends of the cross main beams 116 can be modified by the usage of a spherical bearing, insertion of additional pins, re-orientation of one or both components of the pin joints 124, 132, such that the new pins are oriented perpendicular to the existing pins. Thus, the bending moment caused by the wave and current forces on Float 2 (108b) would not be transferred by the cross main beam 116, but only by the upper main beams (UMB) 120 or lower main beams (LMBs) 112. For example and without limitation, pin joint 124 may include more than one pin (not shown) in various orientations, such as orthogonal to one another, with one or more intermediary coupling features that allow for rotation of the beams about the pins in said orientations.

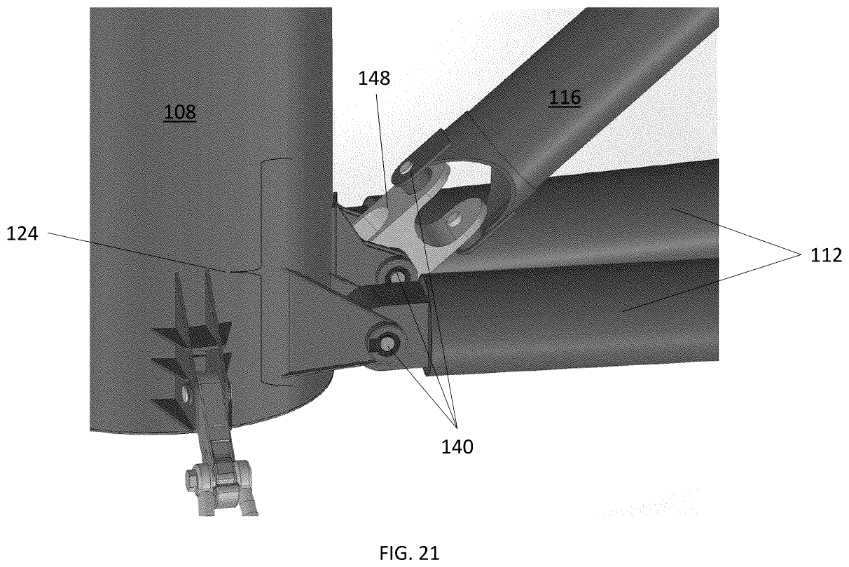

Additionally, the pins can be located at varying heights on the float 108 such that the axis of a first pin is vertically offset from the axis of an adjacent pin. In various embodiments, intermediary coupling feature 148 may be configured to constrain two or more pins in two or more relative angles, for example two pins may be used with a 10 degrees difference in their axes. In various embodiments, intermediary coupling feature 148 may hold the pins in orientations 20 degrees offset from one another. An exemplary intermediary coupling feature 148 is shown in FIG. 21. In various embodiments, intermediary coupling feature 148 may hold the pins in orientations 30 degrees offset from one another. In various embodiments, intermediary coupling feature 148 may hold the pins in orientations 45 degrees offset from one another. In various embodiments, intermediary coupling feature 148 may hold the pins in orientations 90 degrees offset from one another. The coupling feature 148 is configured as having two U-shaped ends, one for coupling with the cross beam 116, and the other end which is oriented 90 degrees for coupling to float 108. Each U-shaped end having two planar “leg” portions with apertures therein for coupling, and an arcuate “bridge” connecting the “legs”.

In some embodiments, the coupling feature is a spherical joint or spherical bearing. The spherical joints or spherical bearings ensure that tension/compression loads are transferred through the beam. Other pin joints can be modified in a similar manner such that only specific, desired loads or moments are transferred through each member.

In various embodiments, intermediary coupling feature 148 may couple any beam to any component described herein, for example and without limitation, intermediary coupling features 148 may couple cross beam 116 to float 108 and/or cross beam 116 to central column 104. In various embodiments, each pin joint is formed from a first and a second pin recess, each pin recess formed with or coupled to each of the components to be pinned together. In various embodiments, any float 108 may include a pin recess formed by two opposite and parallel arms, each arm including a hole sized and configured to receive a pin, such as pin 140. A beam (such as upper beam 120, lower beam 112 or cross beam 116) may be formed with a through hole disposed at one end and transverse to the long axis of the beam. The through hole portion of the beam may be configured to be received by the float-side pin recess arms, wherein the pin is then provided through the three holes, thereby constraining the beam and float to rotate around the axis of the pin, thereby transferring loads in only selected planes of motion.

In various embodiments, each component may be formed with an opposite and opposing pin recess that when brought into alignment form a straight hole for receiving a pin. For example, the central column 104 may include a boss having a hole disposed therein and perpendicular to the vertical axis of the central column 104. The cross beam 116 may include an oppositely formed boss mirroring the central column boss and similarly having a hole therein. The two bosses may be brought into contact or close to contact, wherein the holes are horizontally aligned and a pin 140 may be provided to constrain the beam and central column together, thereby allowing relative rotation of the components around the axis of the pin 140.

Lower beams 112 extending from floats 108a-b are coupled to central column 104 at a common pin joint 128. Pin joint 128 may be a boss, housing, standoff or other component configured to receive and relatively position at least two pins 140, such as at a relative angle such that the lower beams 112 on either side of pin joint 128 are disposed symmetrically. Pin joint 128 may position the two pins 140 in the same plane, such that the plane of rotation of both lower beams 112 are parallel to the vertical axis of column 104. Pin joint 128 may include one or more structural features, ribs, struts, beams or the like and configured to stiffen, strengthen, or bolster pin joint in one or more directions. In various embodiments, pin joint 128 may be integrally formed in one or both of central column 104 and/or lower beams 112. In various embodiments, pin joint 128 may be formed with a plurality of pin holes, each configured to receive pin 140 and adjust the coupling point of one or more lower beam 112.

In various embodiments, each beam, float, and column may be coupled together utilizing one or more connection types that allow for relative rotation. In various embodiments, cross beam 116 may be coupled to the central column 104 via a ball and socket joint, a universal joint, or the like.

A first tower section 1102 is coupled with the central column. The first tower section 1102 is a modular component that can be used as a base of, for example, a wind turbine. The first tower section 1102 can include the necessary electrical components or accessories to install the same to deliver the power generated by the turbine to an electrical station coupled to the semi-submersible platform.

In various embodiments, truss tubulars and buoyancy chambers can be mass produced remotely and shipped to the assembly site. The tubulars (beams) can be positioned and the pins can be inserted relatively quickly. Thus, the final assembly of the offshore platform can take place without any welding, which can decrease time and the necessary manpower.

### Method of Assembly of an Offshore Platform

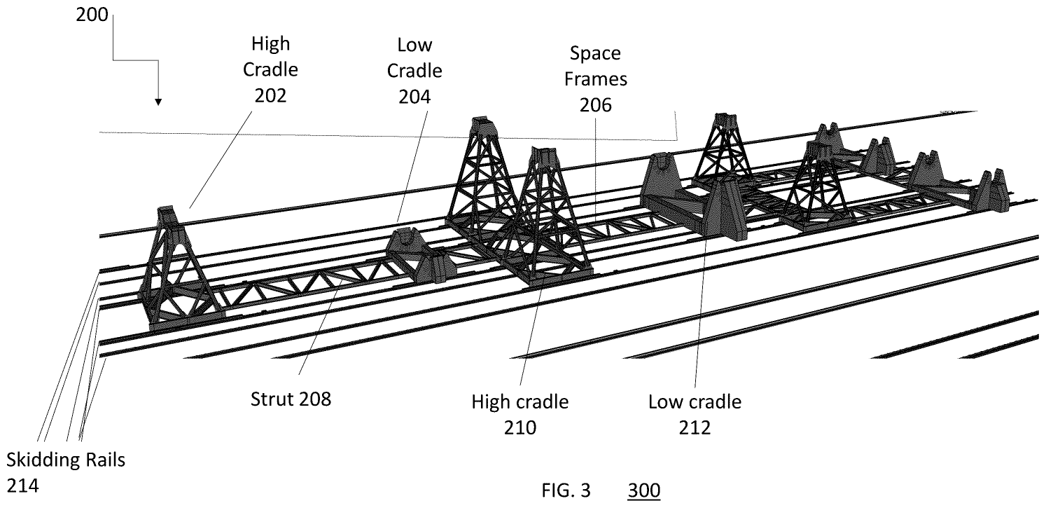

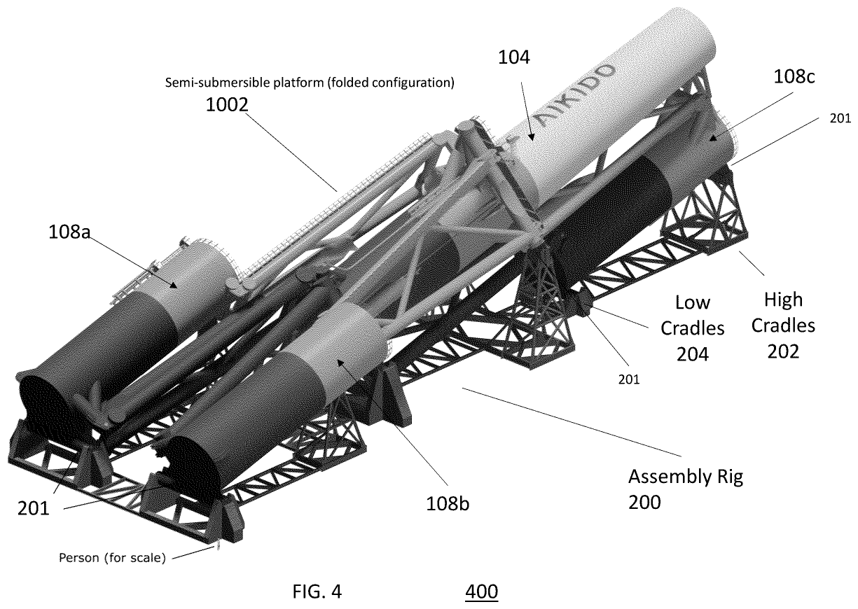

FIG. 3 and FIG. 4 are views 300 and 400, respectively, of example embodiments of the custom-designed assembly rig 200. FIG. 3 is an isometric view 300 of a custom-designed assembly rig 200 having cradles 202, 204, 210, 212 and space frames 206 assembled on skidding rails in accordance with the disclosed subject matter. The assembly rig aligns the respective component (floats, central column and beams) such that the coupling features (e.g. flange holes for receiving pins) are properly aligned, and holds the semi-submersible platform together with precision so that pins can be inserted within the, aligned, pin joints. It can be appreciated that to insert a pin into a pin joint, the components being connected by that joint should be aligned appropriately, accordingly in some embodiments the cradles of the rig can move relative to each other to align connection points between the different components of the floating wind turbine platform. The assembly rig, its cradles, and mating interfaces for the mating appurtenances, are configured for this goal. In some embodiments,

The custom-designed assembly rig 200 comprising of appurtenances 201 (as also illustrated by 1004 in FIG. 4), high cradles, 202, 210, low cradles, 204, 212, and space frames 206 can be assembled along the skidding rails at the assembly site. Space frames 206 may comprise of strut 208 or a plurality thereof. Struts 208 may be alternating and angled relative to the next proximal strut 208 to form an alternating diagonal pattern (e.g., a zig-zag pattern) between the outermost beams of each space frame 206 coupled thereto. Struts 208 may span the distance therebetween the outermost beams of each space frame 206, oriented perpendicular to the outermost beams of each space frame 206 and/or at an acute angle thereto and welded/or pinned to the outermost beams of each space frame.

High cradle 202, 210 low cradle 204, 212 and space frames 206 may be offloaded from a returning barge and moved to the area behind the skidway for storage. Cradles 202, 204, 210, 212 may be stored behind the skidding rails 214 and within reach of the gantry crane. Cradles 202, 204, 210, 212 and space frames 206 can be lifted into position along the skidding rails 214 using a gantry crane and/or mobile crane. The distance between cradles 202, 204, 210, 212 can be fixed using the space frames 206. A person of ordinary skill in the art can recognize that the fixed distance between cradles 202, 204, 210, 212 can vary based on the dimensions of the columns. The number of appurtenances 201, high cradles 202, 210 low cradles 204, 212 and space frames 206, their respective positions relative to each other on the skidding rails 214, and the heights of high cradles and low cradles can vary and depends on the configuration of the columns, such as the plurality of floats 108, the radial distance of the floats 108 from the central column 104, and the distance of floats 108 to each other as illustrated by FIG. 1.

In some embodiments, the cradles 202, 204, 210, 212 are paired to position a column or other element of the semi-submersible platform under construction can be stored at an angle. Each pair includes one high cradle 202, 210 and one low cradle 204, 212. For example, high cradle 202 and low cradle 204 can be paired, and high cradle 210 and low cradle 212 can be paired.

FIG. 3 further illustrates high cradle 210 and low cradle 212. The assembly rig 200 can include multiple pairs of high cradles and low cradles, respectively, creating different height pairings to hold components of the semi-submersible platform (e.g., columns) in different locations and at angles. In some embodiments, the assembly rig 200 includes one pair of high and low cradles, two pairs of high and low cradles, three pairs of high and low cradles, or any other number of pairs.

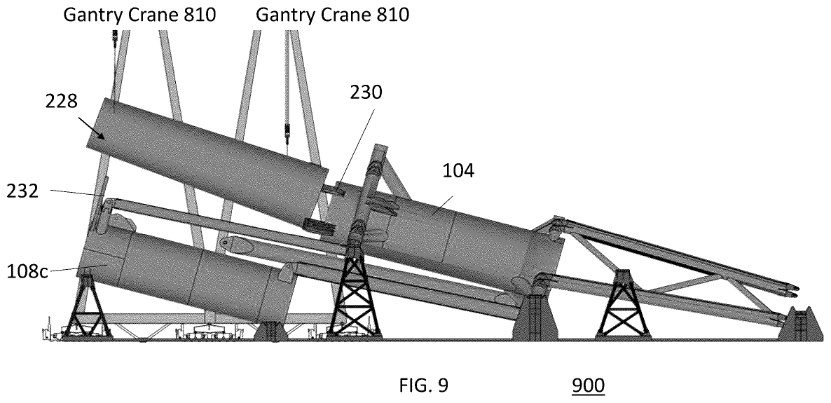

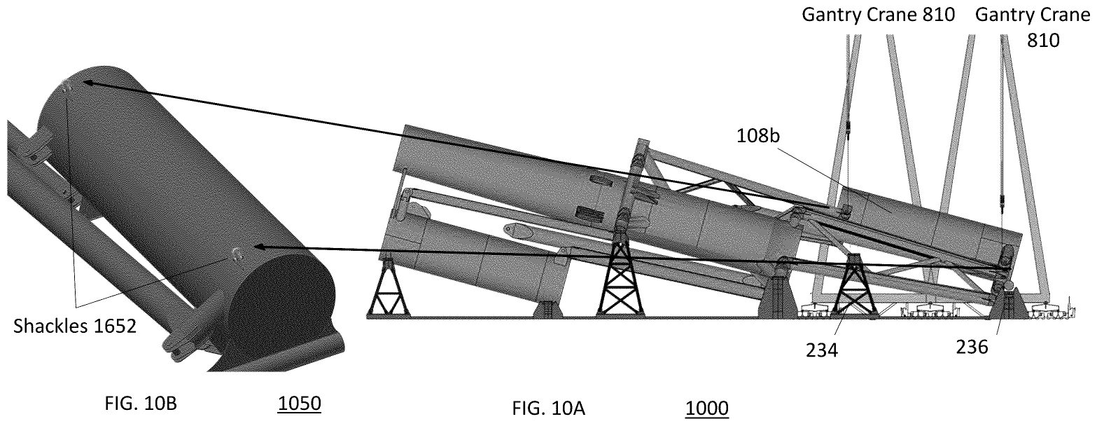

FIG. 4 is an isometric view 1000 of a semi-submersible platform 1002 in an assembly and transport configuration on the assembly rig 200 illustrated by FIG. 9 with the high cradles 202, low cradles 204, and space frames 206 in accordance with the disclosed subject matter. As can be seen by FIG. 10, the differing heights between the high cradle 202 and low cradle 204 supports the folded configuration of the semi-submersible platform 1002 by allowing folded portions to be stowed within the volume of the assembly rig. Mating appurtenance 1004 are provided on the columns, towers, and beams, and facilitate connections to respective the cradles of the assembly rigs. The mating appurtenances assist positioning each of the components accurately so pins can be inserted into the pin joints.

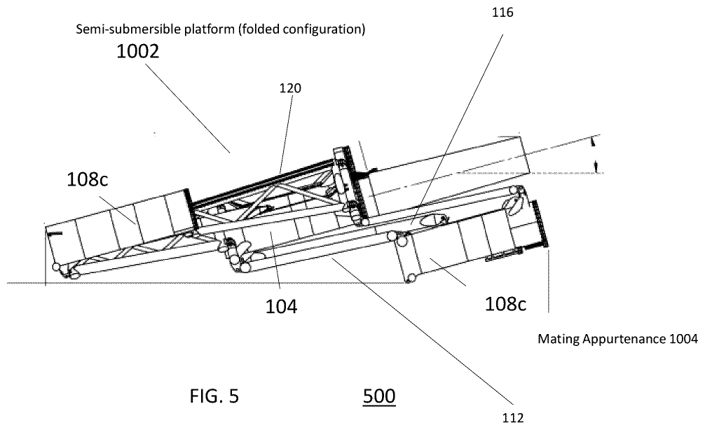

FIG. 5 is a side view 500 of example embodiments of a semi-submersible platform 1002 in an assembly and transport configuration wherein the folded platform configuration is angled with respect to the ground and the angle depends on the heights of the cradles. As is illustrated by FIG. 5, the semi-submersible platform 1002 is folded in a configuration where the columns 108a-c and central column 104 are positioned along axes that are parallel or about parallel with axes of the upper main beams 120, lower main beams 112, and cross beams 116. It can be seen that the axes being about parallel can include being in parallel with a tolerance of up to 1 degree, up to 2 degrees, up to 3 degrees, up to 4 degrees, up to 5 degrees, or up to 10 degrees

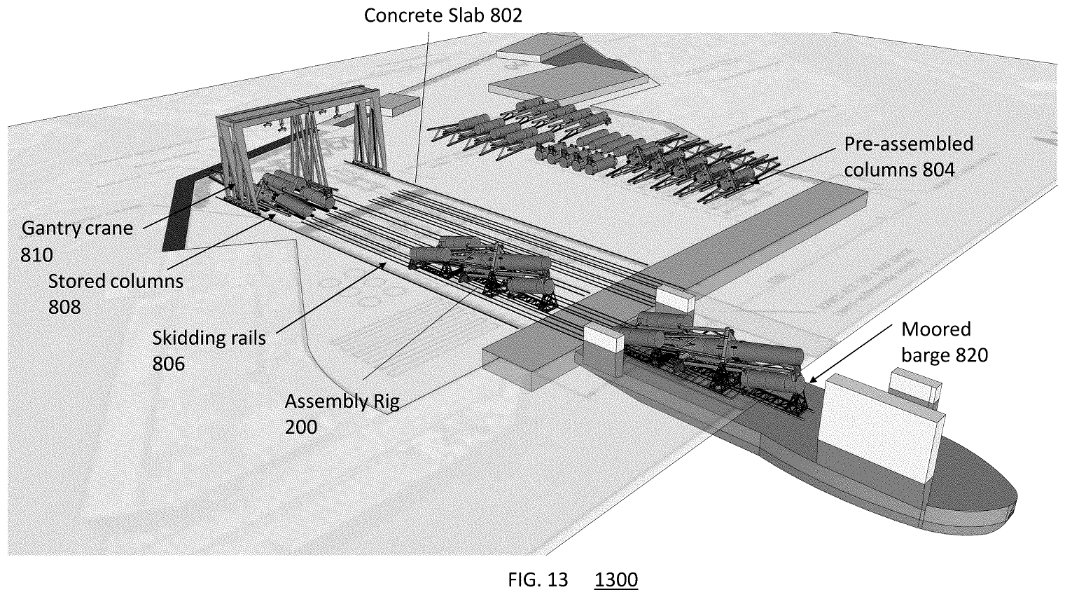

Each of the components of the semi-submersible platform in the folded configuration 1002, which may comprise of pre-assembled columns 804 as illustrated in FIG. 13, can be lifted onto the assembly rig 200 using gantry cranes 810 with slings, lashing, existing pins locked, and/or shackles. The trusses (e.g., upper main beam, lower main beam, cross beam and struts 152) that connect the columns of the semi-submersible platform can be pre-assembled onto the columns outside of the skidway before the columns are positioned on the assembly rig 200. For purpose of illustration and not limitation, pre-assembled components can include the central column 104 configured to be coupled with the LMBs 112, the cross main beam 116, the UMBs 120, and lashing securing the same; columns 108a-c configured to be coupled with the cross main beam 116, the UMBs 120, and lashing used to secure the same.

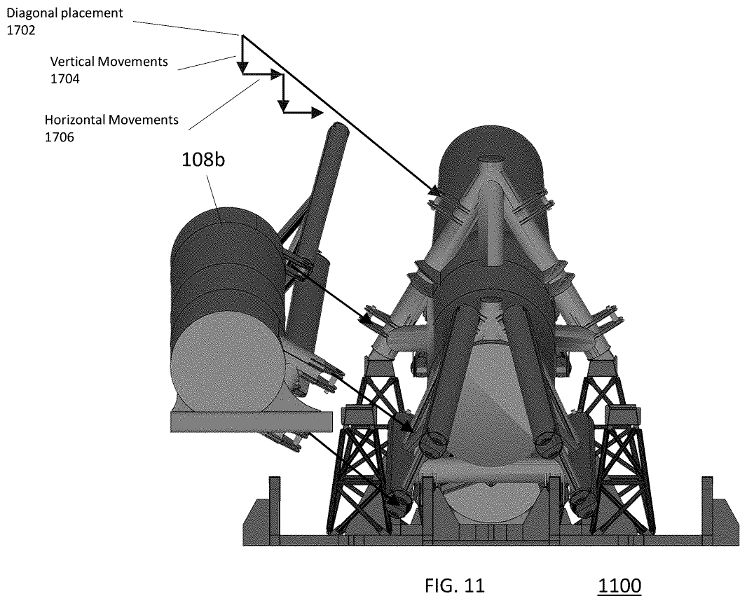

FIG. 11 is an illustration of the semi-submersible platform of FIG. 10 being unfolded into the operational upright configuration. Therefore, it can be recognized that the semi-submersible platform of FIG. 10 and FIG. 11 share many elements while being in a different configuration.

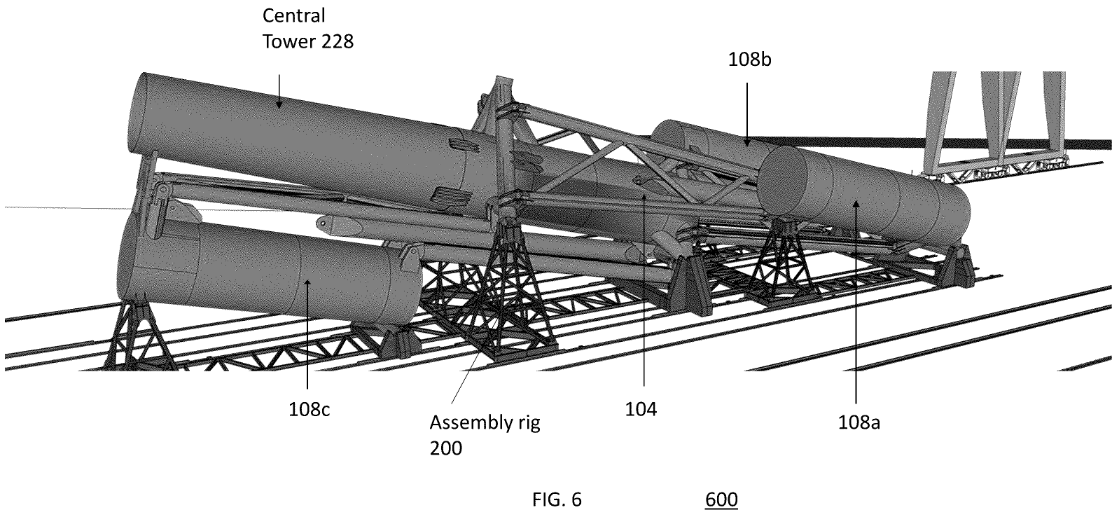

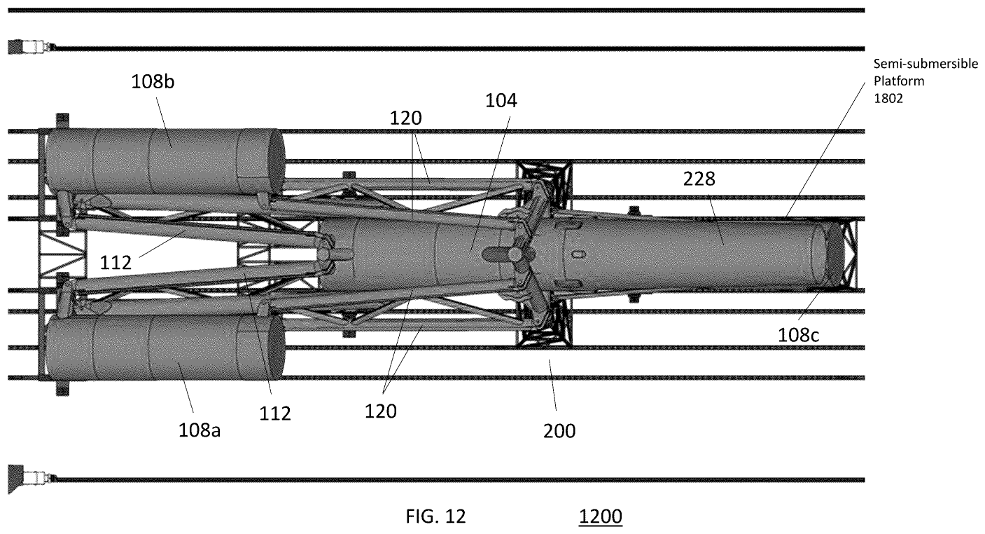

FIG. 6 is an isometric view 600 of a semi-submersible platform in an assembly and transport configuration and an assembly rig 200 assembled along skidding rails in accordance with the disclosed subject matter. The components of the semi-submersible platform 100 are assembled and coupled with a plurality of mating appurtenances 201 that can at least partially selectively couple, fit into or on top of a structure, such as on the custom-designed assembly rig 200 as shown in FIGS. 3, 4, 6, and 13 comprising of mating appurtenances 201, cradles 202, 204, 210, 212 space frames 206, and trusses. FIG. 12 illustrates the semi-submersible platform assembled on the assembly rig 200. Each of the four pre-assembled columns 804 can be placed onto the assembly rig 200 in succession. After each pre-assembled column is lowered, cherry pickers can be used to facilitate insertion of the pins 140 into joints by technicians.

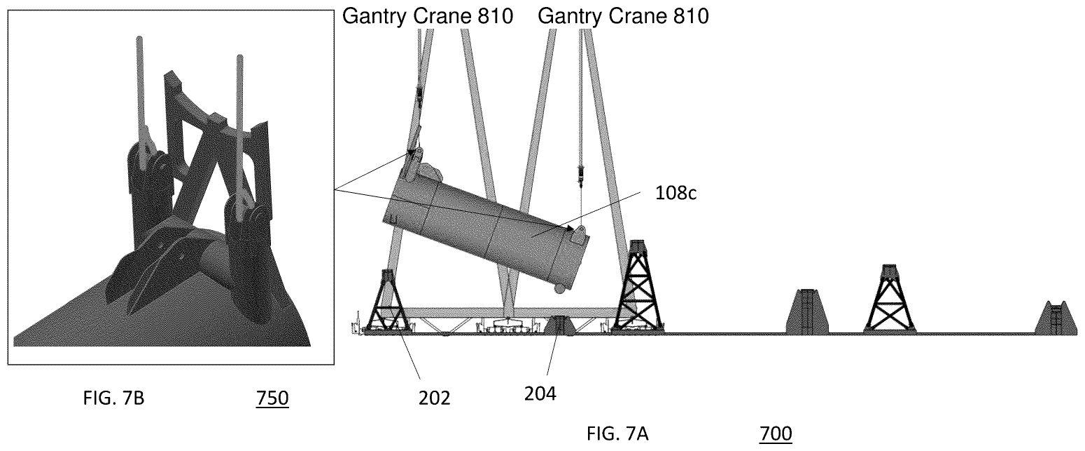

FIGS. 7A-B are views 700 and 750 of a gantry crane lifting a column onto cradles of a custom-designed assembly rig in accordance with the disclosed subject matter. FIG. 7A is a diagram 1300 illustrating gantry cranes lowering the third column 108c onto the high cradle 202 and low cradle 204 of the assembly rig 200. FIG. 7B is a diagram 1350 illustrating mating appurtenances of the gantry crane 810 and the third column 108c. In some embodiments, the gantry crane is connected to the column by the use of cables. Column 108c is lifted onto the assembly rig using gantry cranes, slings, lashing, and existing pins locked such that one end of column 108c is placed on top of high cradle 202 and the other end of the column is placed on top of low cradle 202.

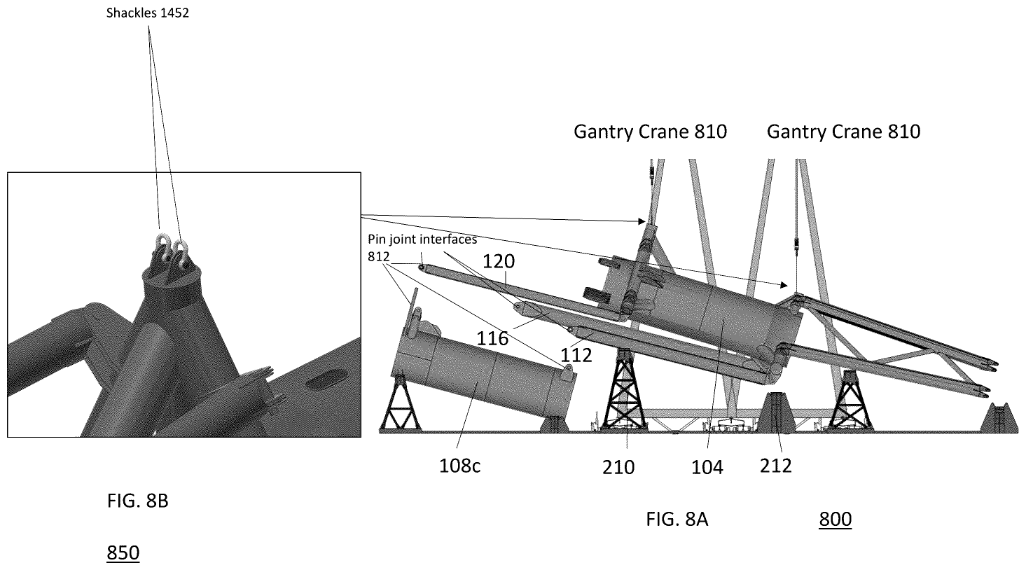

FIGS. 8A-B are view 800 and 180 of a gantry crane lifting a pre-assembled column with beams onto cradles of a custom-designed assembly rig in accordance with the disclosed subject matter. FIG. 8A is a view 800 illustrating gantry cranes 810 that are moved to the pre-assembly comprising of column 104 with the LMBs 112, cross main beam 116, and UMBs 120. Column 104 with the LMBs 112, cross main beam 116, UMBs 120 is lifted onto the assembly rig using the gantry cranes 810, shackles 1452 slings, and/or lashing. The UMBs 120, LMBs 112, and cross main beam 116 are lashed independently (not shown for the beams). The pre-assembly comprising of column 104 with the LMBs 112, cross main beam 116, and UMBs 120 engages with high cradle 210 and low cradle 212. Pin joint interfaces 812 are on one or more ends of each respective beam (e.g., upper main beam, lower main beam, cross beam) and are available for coupling to one or more of the columns 108a-c or 104 once placed in the assembly rig 200 and thereby aligned for pin insertion.

FIG. 8B is a view 850 illustrating an embodiment of a mating interface between the central tower 104 and the gantry crane 810. As described above, the central tower 104 may be lifted by connecting the gantry crane 810 to the shackles 1452, for example using a sling hook (not shown).

FIG. 9 is a view 900 of a gantry crane lifting a tower guided by column bumpers and column tower support in accordance with the disclosed subject matter. Once central column 104 is placed on the assembly rig 200, column 108c is coupled to the LMBs 112 and the UMBs 120 of column 104 using pin connections. Cherry pickers can be used to activate pins and mobile cranes can be used to adjust the bracing position of column 108c for proper fit of pin connections. Following proper placement, lashing 229 is removed. Gantry cranes 810 are moved to be positioned at and lift tower 228 using slings. A cherry picker truck can be used to supervise the placement of pre-assemblies, columns, and tower 228. Tower 228 is guided using column 104 bumpers 230 and column 108c tower support 232. Tower 228 can be coupled to the rest of the assembly using a bolted connection.

FIGS. 10A-B are views 1000 and 1050 of a gantry crane 810 lifting a pre-assembled column 108b with beams onto high cradle 234 and low cradle 236 of a custom-designed assembly rig in accordance with the disclosed subject matter. Following proper placement of the tower 228 onto the central column 104, lashing 229 is removed, and cranes can be moved to column 108b. Column 108b is lifted onto the assembly rig using gantry cranes 810 and shackles. Column 108b is placed such that one end of the column is placed on top of high cradle 234 and the other end of the column is placed on top of low cradle 236.

FIG. 10B is a view 1050 illustrating an embodiment of a mating interface between the column 108b and the gantry crane 810. As described above, the column 108b may be lifted by connecting the gantry crane 810 to the shackles 1652, for example using a sling hook (not shown).

FIG. 11 is a view 1100 illustrating example embodiments of horizontal and vertical movements utilized by the gantry crane 810 to position a pre-assembled column 108b with beams on cradles of a custom-designed assembly rig in accordance with the disclosed subject matter. In some embodiments, gantry cranes 810 are operated such that diagonal placement 1702 of column 108b is achieved by stepped vertical movements 1704 and horizontal movements 1706. In some embodiments, the diagonal placement 1706 can be about 45 degrees, but a person of ordinary skill in the art can recognize that other angles can be employed. A person of ordinary skill in the art can further recognize that in some embodiments, the diagonal placement 1702 refers to a diagonal of the starting position from the location of the column 108b in the gantry crane 810 to the mounting position in the assembly rig 200, and the movements in between may be non-linear. Mobile cranes 810 can be used to adjust the bracing position of column 108b. Following proper placement, lashing 229 is removed. Column 108a (not shown) may be added to the assembly rig 200 using a similar set of steps and diagonal placement.

FIG. 12 is a top view of a semi-submersible platform 1202 in an assembly and transport configuration on a custom-designed assembly rig 200 along skidding rails in accordance with the disclosed subject matter. The semi-submersible platform 1802 comprises multiple pre-assemblies. A first preassembly includes column 108a with UMBs 120 and is coupled to column 104 with LMBs 112 via pin connections. A second pre-assembly comprising of column 108b with UMBs 120 can be coupled to column 104 with LMBs 112 via pin connections. Cherry pickers can be used to activate pins. The components of the semi-submersible platform 100 can be coupled using methods for coupling concrete components, steel, aluminum, alloys thereof, or another metal or metal alloy components. The methods for coupling materials comprising of welded connection, bolted connection, pinned connection, grouted connection, or other methods for coupling metals or coupling concrete components.

The relative motion allowed between each beam, float, and column by utilizing one or more connection types can allow a folded configuration of the semi-submersible platform 100 such as that illustrated by FIGS. 6-12 and FIG. 14. The folded configuration may reduce the space needed for assembly, the cost for assembly, and/or duration of assembly. In some embodiments, the folded configuration of the semi-submersible platform 100 and assembly rig 200 can be moved or skidded along the rails and loaded onto a barge 820. The displacement can be incremental and with all cradles moving in unison. In some embodiments, the folded configuration of the semi-submersible platform 100 can be skidded down a skidway and directly into the water. In some embodiments, assembly rig 200 can also be placed in a dry dock, and the dry dock can be flooded, allowing the assembly rig 200 to float and be placed on a partially submerged barge, connected to a tug boat, or deployed on site at the dock. In various embodiments, the folded configuration of the semi-submersible platform 100 and/or assembly rig 200 may be PANAMAX compliant. The assembled floater and tower base is further configured to have a height that can fit under bridges when on the deck of a boat.

FIG. 13 is a view 1300 of the assembly site of the semi-submersible platform wherein a concrete slab with load spreading is embedded with sets of skidding rails and skid beams in accordance with the disclosed subject matter. In various embodiments, the assembly of the semi-submersible platform can take place at a quayside, dry dock, or area that has direct access to water. In some embodiments, the area used for assembly can be prepared by building a concrete slab 802 meeting minimum soil bearing capacity, or using supports or local ground reinforcements to meet the available soil bearing capacity or local ground reinforcements. The concrete slab 802 with load spreading can be embedded with sets of skidding rails 806 and skid beams extending in the longitudinal direction of a barge. A gantry crane 810, described in further detail below, positions stored columns 808 into a loading configuration along the skidding rails 806 for transport onto a moored barge 820. In some embodiments, other crane types can be used, as can be envisioned by a person of ordinary skill in the art in light of the present disclosure. The stored columns 808 can be positioned behind the assembly line within reach of the gantry crane 810. The assembly site can further store pre-assembled columns 804 that can be loaded into position under the gantry crane 810 and loaded onto the moored barge 820 as described above.

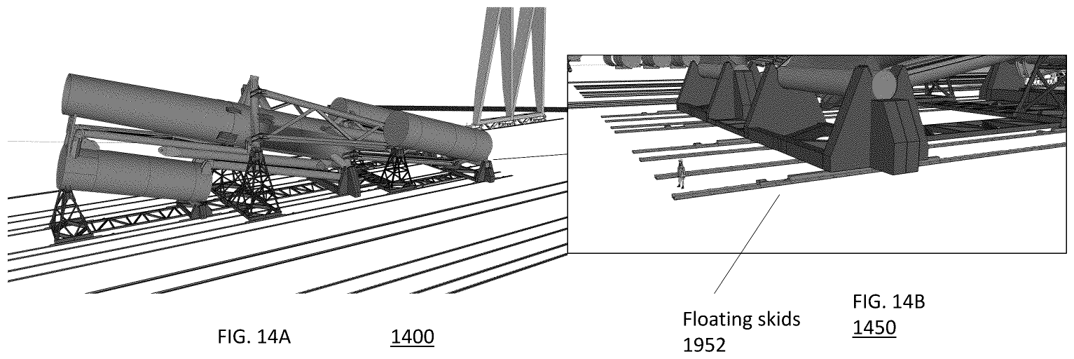

FIGS. 14A-B are views 1400 and 1450 of floating skids used with a custom-designed assembly rig 200 to skid (e.g., slide) an assembly rig and semi-submersible platform in accordance with the disclosed subject matter. Columns and assembly rig can be mobilized by a group of individuals, gantry cranes, mobile cranes, and cherry pickers. Columns as assembled on the assembly rig 200 can be skidded along the skidding rails 214 using floating skids 1452 as shown in FIG. 14B.

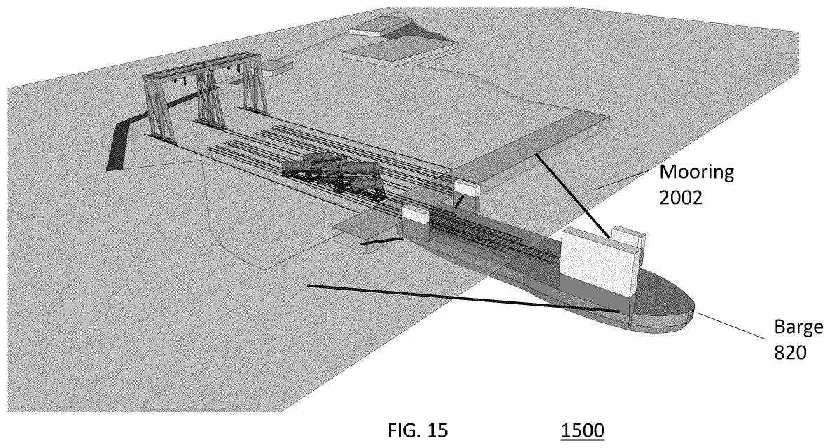

FIG. 15 is a view 1500 of a moored barge 820 at the assembly site for a semi-submersible platform in accordance with the disclosed subject matter. The barge 820 can be moored (e.g., secured to the mooring 2002 or dock), as shown in FIG. 15, for example using a ‘Med mooring’ technique, to accelerate load-on. In parallel, the assembly comprising of the folded configuration of the semi-submersible platform 100 and the custom-designed assembly rig 200 can be skidded to the barge 820. The lines and anchors of the mooring system are per industry standards wherein each mooring line is discretized into an arbitrary number of beam elements, each with their own sectional mass, buoyancy, stiffness, added mass, damping and seabed drag coefficients.

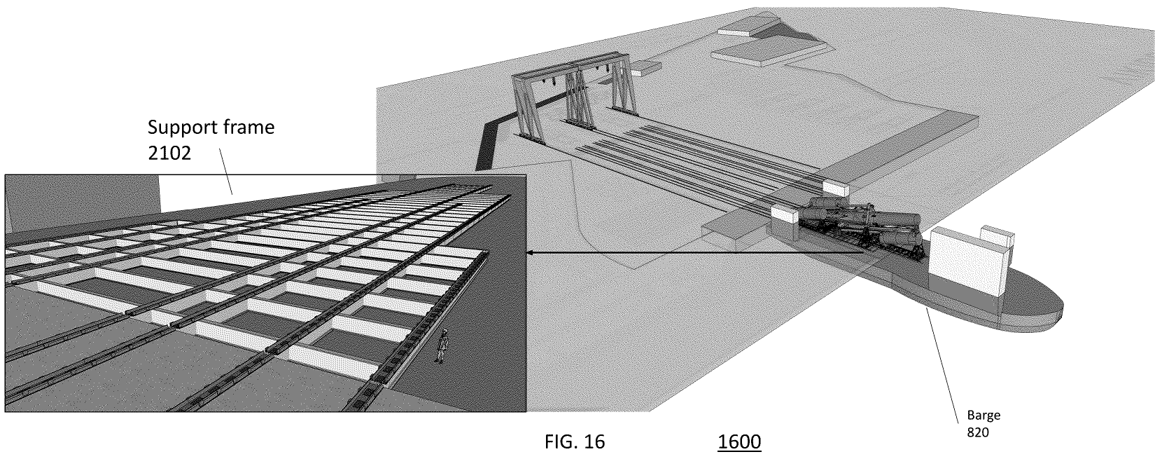

FIG. 16 is a view 1600 of a semi-submersible platform on a support frame on a barge in accordance with the disclosed subject matter. Skidding onto a barge 820 requires precise draft control of barge due to tidal variations. Therefore, the barge 820 can also be ballasted by using for example the semi-submersible caissons as ballast tanks to control draft of the barge. Mooring and ballasting maintain a continuous rail path from the dock to the support frame, which may be an HEB support frame 2102, on the barge. The folded configuration of the semi-submersible platform and assembly rig 200 are secured to the barge via seafastening connections to the HEB support frame 2102 that align the skidding rails 214 on the dock with the support frame 2102. Cylinder and skids are removed prior to sail away and pin connections are quick released between cradles and space frames. Sailing window requires coordination with harbormaster and local pilots. Compared to a wet tow, transporting the semi-submersible platform with the barge 820 can greatly reduce transit time. Once the barge 820 is on site, the tow lines, ballast, air and power umbilicals are connected to the platform prior to float-off. Columns 108a-b can be temporarily lashed together to ensure roll stability of the platform. Float-off occurs when the caissons on the barge are filled with water.

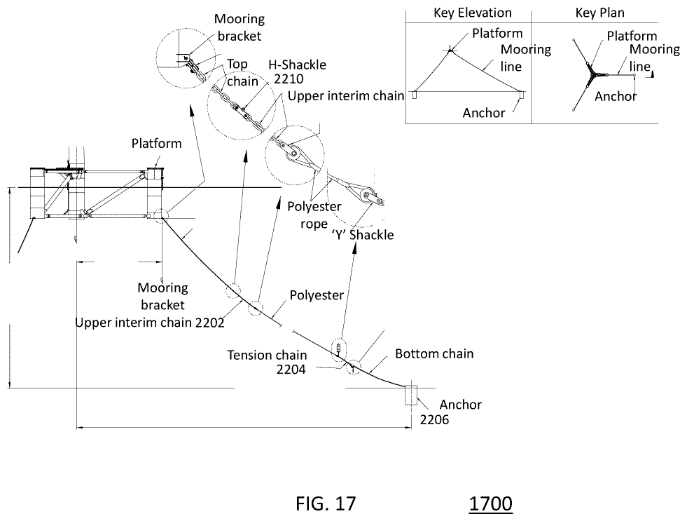

FIG. 17 is a schematic of a semi-submersible platform with a mooring system connected to the outer columns in accordance with the disclosed subject matter. Mooring and cable at the integration site or the site where the semi-submersible platform 100 can be installed asynchronously with all other assembling activities, but may be affected by weather conditions. The lines (e.g., upper interim chain 2202, tension chain 2204, and shackles 2210) and anchors 2206 of the mooring system are per industry standards wherein each mooring line is discretized into an arbitrary number of beam elements, each with their own sectional mass, buoyancy, stiffness, added mass, damping and seabed drag coefficients. For example, the mooring system can be a semi-taut system consisting of three lines per platform connected to the outer columns 108a-c.

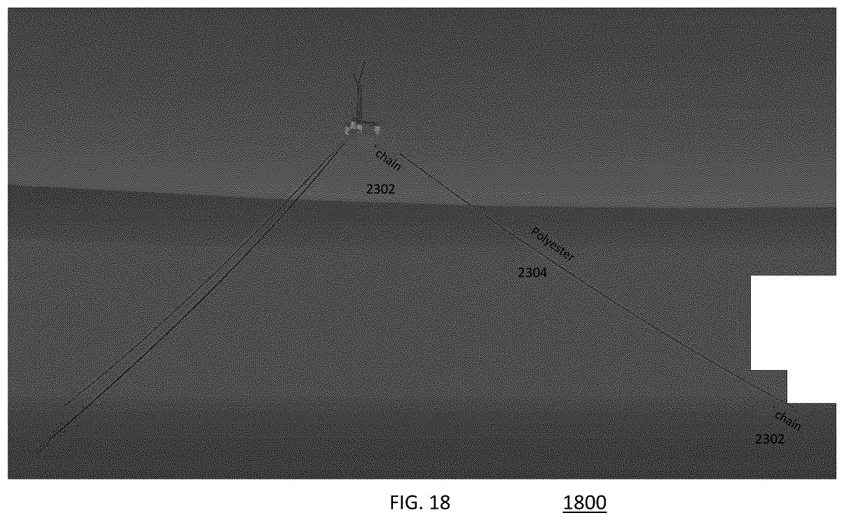

FIG. 18 is a view 1800 of a semi-submersible platform in operational upright configuration with mooring lines 2302 and anchors attached in accordance with the disclosed subject matter. The third and final lines are picked up and the anchor handling tug supply vessel is used to pull the platform toward its final, equilibrium position. In other words the unfolded and upright position as shown in FIG. 1 and FIG. 18 with mooring lines and anchors attached

In some embodiments, software can assist with the global performance analysis. The software allows the user to define various parameters such as environmental conditions, turbine operational conditions, and platform and mooring status. Using these parameters, simulations can be ran to generate a report, e.g., for a classification society. The software can also allow the user to run multiple simulations in parallel batch processing. The software then outputs and postprocesses the simulation results and generates tables and figures for reporting purposes.

Manufacturing and port infrastructure can be severely limited and can be a bottleneck for commercial-scale floating wind. Thus, the semi-submersible platform can take advantage of existing competencies at fabricators that produce truss structures, for example for jacket platforms, and large tubulars, for example for monopiles. Components of the semi-submersible platform arrive at the assembly site finished, including secondary and tertiary steel.

There can be a dedicated production facility for completing fabrication of column 104, which is the heaviest and more complex component of the platform, and a separate production facility for finishing columns 108. No specialized handling equipment may be needed at these manufacturing sites as the weights of the columns can be less than typical weights of completed offshore jackets or monopiles.

To fabricate the trusses and tubulars, existing fabrications yards can be modified to maximize throughput. In some embodiments, additionally or alternatively, purpose-built factories can be built close the final assembly site which may reduce the cost of transporting the columns and accelerate the construction schedule. Tubulars and joints are commonly used throughout the offshore industry and there are several available suppliers and yards that can produce these components.

To reduce corrosion in the pin joints and increase the longevity of the pins, pin liners and bearings can be used. All joints use pin liners with thrust washers in addition to join connections to the cross main beams. The cross main beams can use spherical bearings to ensure that only tension and/or compression loads are transferred through the beam. The cross main beams can use spherical bearings to ensure that only tension and/or compression loads are transferred through the beam.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A semi-submersible offshore wind turbine platform comprising:
at least one truss having:
a central column, the central column having an upper end and a lower end, defining a length along a vertical axis therebetween;
at least one float having an upper end and a lower end, defining a length along the vertical axis therebetween, the float spaced from the central column;
at least one upper beam coupled to the upper end of the float and the upper end of the central column;
at least one lower beam coupled to the lower end of the float and the lower end of the central column, wherein the lower beam is parallel to the upper beam;
at least one cross beam coupled to the lower end of the float and the upper end of the central column, wherein each of the at least one upper beam, the at least one lower beam and the at least one cross beam are coupled via a plurality of pins to the float and the central column; and
wherein each of the at least one upper beam, the at least one lower beam, and the at least one cross beam are configured to move about an axis of each of the pins.

2. The semi-submersible offshore wind turbine platform of claim 1, wherein the at least one float is a buoyancy chamber.

3. The semi-submersible offshore wind turbine platform of claim 1, further comprising:
a tower affixed to the upper end of the central column along the vertical axis.

4. The semi-submersible offshore wind turbine platform of claim 1, wherein:
the at least one upper beam is coupled to the upper end of the float with a first pin and to the upper end of the central column with a second pin;
the at least one lower beam is coupled to the lower end of the float with a third pin and to the lower end of the central column with a fourth pin;
at least one cross beam is coupled to the lower end of the float with a fifth pin and to the upper end of the central column with a sixth pin.

5. The semi-submersible offshore wind turbine platform of claim 1, wherein, the at least one upper beam and at least one lower beam each define a length between float and central column, the axis being perpendicular to vertical axis of the central column.

6. The semi-submersible offshore wind turbine platform of claim 1, wherein the at least one upper beam and at least one lower beam each define a length between float and central column defining an horizontal axis, the axis being about perpendicular to the vertical axis of the central column.

7. The semi-submersible offshore wind turbine platform of claim 1, further comprising:
a line connection at one or more of the lower end of the float and the lower end of the central column, the line connection facilitating a connection to an anchored tether.

8. The semi-submersible offshore wind turbine platform of claim 1, wherein the at least one float is one or more of: (a) three floats, wherein the three floats are distributed circumferentially around the central column by about 120 degrees and (b) four floats, wherein the four floats are distributed circumferentially around the central column by about 90 degrees.

9. The semi-submersible offshore platform of claim 1, further comprising:
an intermediary coupling that includes a first pin and an adjacent pin, an axis of a first pin being vertically offset from the axis of an adjacent pin.

10. An assembly rig for assembling a transportable a semi-submersible off-shore wind turbine platform comprising:
a first cradle having a lower end and an upper end, defining a first vertical length, the upper end of the first cradle forming a first mating interface for a first end of a first column;
a second cradle having a lower end and an upper end, defining a second vertical length, the upper end of the second cradle having a second mating interface for a second end of the first column;
a third cradle having a lower end and an upper end, defining a third vertical length, the third cradle having a third mating interface for a first end of a second column;
a fourth cradle having a lower end and an upper end, defining a fourth vertical length, the upper end of the fourth cradle having a fourth mating interface for a first end of a beam attached to the second column;
a fifth cradle having a lower end and an upper end, defining a fifth vertical length, an upper end of the fifth cradle having a fifth mating interface for a first end of a third column; and
a sixth cradle having a lower end and an upper end, defining a sixth vertical length, the sixth cradle having a sixth mating interface for a second end of the third column;
wherein the first vertical length is less than the second vertical length, the third vertical length is less than the fourth vertical length, and the fifth vertical length is less than the sixth vertical length;
wherein the first column, second column, third column, and the beam include pin joint interfaces thereon, such that when the first column, second column, third column, and the beam are coupled with the respective first, second, third, fourth, fifth, and sixth mating interfaces, the pin joint interfaces are aligned for pin insertion.

11. The assembly rig for transporting a semi-submersible off-shore wind turbine platform of claim 10, wherein the third cradle further includes a seventh mating interface for a second end of the beam.

12. The assembly rig for transporting a semi-submersible off-shore wind turbine platform of claim 10, further comprising:
a plurality of struts connecting, along a horizontal dimension, the first, second, third, fourth, fifth, and sixth cradle at their respective lower ends.

13. The assembly rig for transporting a semi-submersible off-shore wind turbine platform of claim 10, wherein the assembly rig is configured to be placed upon a plurality of skidding rails, the skidding rails configured to mate with rail elements of the first, second, third, fourth, fifth, and sixth cradle, said mating allowing the first, second, third, fourth, fifth, and sixth cradle to move along a horizontal dimension of the plurality of skidding rails.

14. The assembly rig for transporting a semi-submersible off-shore wind turbine platform of claim 13, wherein the plurality of skidding rails is aligned with a barge, such that the first, second, and sixth cradle, and the first, second and fifth cradle can be loaded onto the barge.

15. A method of assembling a semi-submersible wind turbine platform, the method comprising:
securing the floating column to a crane;
moving the floating column to a first cradle and second cradle of an assembly rig;
mounting a beam to a central column with a second pin joint;
securing the central column to the crane;
moving the central column to a third and fourth cradle of the assembly rig;
aligning the floating column and the central column in the assembly rig such that a first pin joint interface of the beam mounted to the central column is aligned with a second pin joint interface of the floating column;
mounting the floating column to the beam by inserting a pin through the first pin joint interface and second pin joint interface.

16. The method of assembling a semi-submersible wind turbine platform of claim 15, wherein the floating column is a first floating column, and the method further comprises:
securing a second floating column to the crane;
moving the second floating column to a fifth cradle and sixth cradle of the assembly rig.

17. The method of assembling a semi-submersible wind turbine platform of claim 15, wherein the first cradle has an upper end and a lower end defining a first height, the second cradle has an upper end and a lower end defining a second height, and the first height is greater than the second height;
wherein the third cradle has an upper end and a lower end defining a third height, the fourth cradle has an upper end and a lower end defining a fourth height, and the third height is greater than the fourth height.

18. The method of assembling a semi-submersible wind turbine platform of claim 15, further comprising:
moving the assembly rig along skidding rails, the assembly rig having floating skids engaged with the skidding rails along an axis formed by a length of the skidding rails; and
transferring the assembly rig to a barge along the skidding rails.

19. The method of assembling a semi-submersible wind turbine platform of claim 15, wherein the floating column, the central column, the at least one upper beam, the at least one lower beam, and the at least one cross beam compose the semi-submersible platform, the method further comprising:
deploying the semi-submersible platform from a barge by sinking the barge and thereby releasing the semi-submersible platform in water;
configuring the semi-submersible platform by moving the at least one upper beam and the at least one lower beam into a position whereby a length of the respective beams is perpendicular to a length of the float column and central column.

20. The method of assembling a semi-submersible wind turbine platform of claim 19, further comprising:
mounting a second beam to the floating column;
aligning the floating column and the central column in the assembly rig such that a third pin joint interface of the second beam mounted to the floating column is aligned with a fourth pin joint interface of the central column.
